(19) United States
(12) Patent Application Publication
(10) Pub. No.: US 2008/0288303 A1
(43) Pub. Date: Nov. 20, 2008

(54) Method for Detecting and Preventing Fraudulent Internet Advertising Activity

(75) Inventors: Richard J. Gray, Emerald Hills, CA (US); Dominic V. Bennett, Los Altos, CA (US)

Correspondence Address: CLARIA CORPORATION;c/o HAYNES BEFFEL & WOLFELD LLP, P.O. BOX 366, 751 KELLY STREET, HALF MOON BAY, CA, 94019, US

(73) Assignee: Claria Corporation, Redwood City, CA (US)

(21) Appl. No.: 11/688,160

(22) Filed: Mar. 19, 2007

Related U.S. Application Data
(60) Provisional application No. 60/783,231, filed on Mar. 17, 2006.

(51) Int. Cl. G06Q 10/00

(52) U.S. Cl. 705/7; 705/1

(57) ABSTRACT

A method for preventing fraud in Internet-based advertising. The first step of this method is providing behavior-tracking software on a user computer. That software tracks and analyzes the user's activity across multiple content providers. Next, the system displays content, including advertising, based on preferences inferred from previous activity. Finally, the system identifies behavior patterns consistent with fraudulent activity.

### RELATED APPLICATION

This application claims the benefit of U.S. Provisional Patent Application No. 60/783,231, entitled “Method and System for Preventing Click Fraud” filed on Mar. 17, 2006 by Richard Gray and Dominic V. Bennett. That application is incorporated by reference for all purposes.

### BACKGROUND OF THE INVENTION

The present invention relates to fraud prevention. In particular, it relates to the prevention of fraud associated with the presentation of advertising on the Internet.

The rise in usage of the Internet led quickly to its employment as a medium of advertising. Several years into this phenomenon, advertising is now ubiquitous on the Internet, whether as stand-along pop-up or pop-under windows, or banner ads positioned at the top of pages and other ads placed at other locations on webpages.

The assignee of the present application is the owner of a number of previous applications dealing with behavioral targeted advertising on the Internet. In particular, U.S. application Ser. No. 10/057,413 entitled “System, Method and Computer Program Product for Presenting Information to a User Utilizing Historical Information About the User” filed on Jan. 25, 2002 (now U.S. Pat. No. 7,181,488 B2); Ser. No. 10/174,403 entitled “System and Method for Using Continuous Messaging Units in a Network Architecture” filed on Jun. 17, 2002; Ser. No. 10/056,932 entitled “System, Method and Computer Program Product for Collecting Information About a Network User” filed Jan. 25, 2002 (now U.S. Pat. No. 7,149,704 B2); and Ser. No. 11/226,066 entitled “Method and Device for Publishing Cross-Network User Behavioral Data” filed on Sep. 14, 2005. These applications, hereinafter referred to as the “Behavioral Targeting Applications,” are hereby incorporated herein for all purposes.

The success of such advertising has, unfortunately, also given rise to a number of schemes that fraudulently exploit various features of different forms of Internet advertising. One general type is known as “click fraud,” and it takes two forms. One type involves pay-per-click (PPC) advertising, in which the advertiser pays the ad publisher a set amount each time an ad viewer clicks on the ad. The rationale for that payment model is straightforward—clicks should indicate a highly successful ad placement, as the ad stimulated the viewer to take positive action, which actions presumably lead to customer purchases a certain percentage of the time. What has been found, however, is that competitors of the advertiser can generate a number of such clicks, which then cost the advertiser money without returning any benefit. The competitor who can work this racket successfully can seriously boost a competitors cost of doing business. This form of fraudulent activity is generally known as a “click-through” attack.

A second method of “click fraud” attacks “affiliate advertising” programs, such as Google's AdSense, in which a content provider site (often a blog or special interest site) enters into an arrangement with a publisher, such as Google or Yahoo!, under which the publisher provides advertising to the site, often advertising tailored to the subject matter of the site itself, and the fees generated by any user clicks are split between the site owner and the publisher. Clearly, if the site owner can generate a high volume of clicks, it can increase its income substantially. This form of fraudulent activity is generally known as an “inflation” attack.

Click fraud perpetrators were not slow to realize the need to automate clicking in order to maximize revenue and evade detection. Thus, few click fraud schemes involve actually persons doing the clicking. Rather, special programs or scripts automate the process. The international nature of the Internet makes it possible for such operations to be conducted in areas where the perpetrators are relatively immune from prosecution, making it possible to operate a number of computers running click fraud programs, attacking a number of advertisers. In addition, viruses can run click fraud scripts and programs from within infected systems, completely unknown to the innocent owner's knowledge. Simple versions of this technique involve simply logging on to a site and emulating the message stream that would indicate navigation to the ad and a subsequent click. More sophisticated attacks go so far as to follow an attack by uninstalling the current instance of the browser and deleting any cookies received after the attack, so that a subsequent attack by a new instance of the browser can evade detection algorithms that look for such cookies.

Experts estimate the volume of such attacks to be worth billions of dollars each year in diverted revenue, making it a major problem for Internet advertisers.

A related form of Internet fraud is so-called “phishing,” an activity that seeks to trick legitimate users into divulging personal information, such a credit card numbers, account numbers, or passwords. Typically, such attacks start with an email message, often a message that purports to warn the recipient of a problem, with a bank account, for example. The email includes a hyperlink, which takes the user to a website where the landing page may ask for account information, to “verify” the user's identity. With the information thus obtained, the “phisher” can attack the victims various accounts. In some instances, the landing page also attempts to send virus code to the victim.

Although many portions of the Internet advertising community are striving to solve these problems, no solution has yet been found. Thus, the art remains in needs of an effective method for preventing Internet fraud.

### SUMMARY OF THE INVENTION

An aspect of the invention is a method for preventing fraud in internet-based advertising. The first step of this method is providing behavior-tracking software on a user computer. That software tracks and analyzes the user's activity across multiple content providers. Next, the system displays content, including advertising, based on preferences inferred from previous activity. Finally, the system identifies behavior patterns consistent with fraudulent activity.

### BRIEF DESCRIPTION OF THE DRAWINGS

FIG. 1a sets out a flow chart for an embodiment of an overall process for detecting and preventing click fraud.

FIG. 1b sets diagrams a data return structure used in an embodiment of a process for detecting and preventing click fraud.

FIG. 2 sets out an embodiment of a method for analyzing assembled advertising data to determine if click fraud has occurred.

FIG. 3 depicts a system including an embodiment of a monitor system for detecting click fraud.

FIG. 4 illustrates in diagram form an embodiment of a system for detecting and preventing phishing fraud.

FIG. 5 sets out a flowchart depicting the embodiment of FIG. 4.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

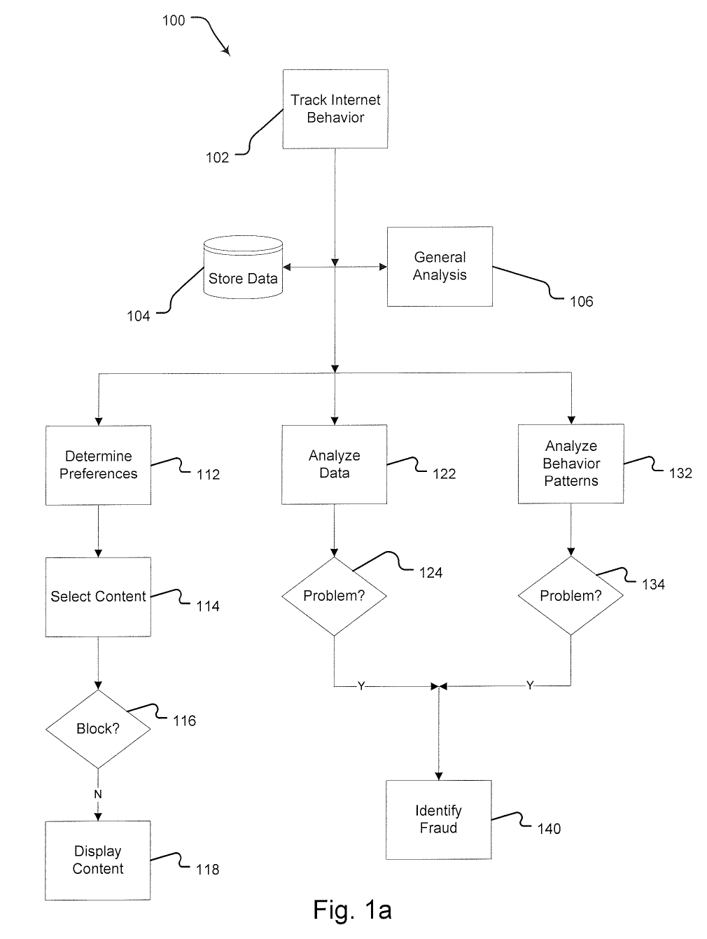

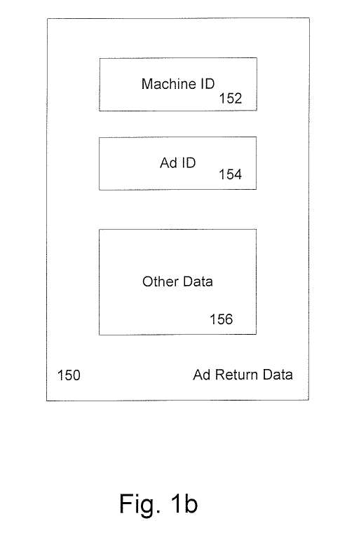

FIG. 1a shows an embodiment 100 of a fraud detection and prevention system as claimed in the present application. The system starts with the task of tracking Internet behavior, in step 102. Those processes are the subject matter of the Behavioral Targeting Applications identified above, which describe and claim various methods of tracking the behavior of a large number of users, over a large number of content providers, over significant periods of time. The dataset made available for analysis by this step generally includes information relating to several million users, tracking the variety of their Internet navigation over a period of weeks or months, running into the hundreds of millions of website visits and other interactions. The gathering of such data occurs at the user level, as detailed in the cited applications, while analysis occurs at a central server location, where data is stored, in database and data warehouse facilities as known in the art, shown in step 104. The data is generally analyzed as well, in step 106, which can take place employing specialized data mining, data analysis or OLAP applications, as will be understood by those in the art.

Specific data analysis can occur in any of three process paths. A first path, in steps 112-118, depicts the typical preference determination analysis undertaken by systems operated by a behavior-oriented marketing system, of determining preferences in step 112, which in one embodiment builds and employs a user profile to determine what material to offer that user, followed by selecting content according to that profile, in step 114. The system uses rules to determine whether the selected content should be blocked from a particular user, because, for example, the user has already been exposed to the selected content. Based on that determination, the selected content can be blocked in step 116. If it passes that test, the content is displayed to a user in step 118.

Analysis of the data for evidence of fraud occurs in two parallel paths, starting at steps 122 and 132, respectively. The former path looks at the data itself for evidence of fraud. For example, a clear example of click fraud would be a large number of clicks, all from the same IP address. Most click fraud perpetrators are too sophisticated to operate in that manner, however, requiring more depth in the analysis carried out in step 122. One approach looks to the origin of the clicks. Legitimate response could be expected to exhibit approximately the distribution of customers, or at least target customers. Thus, a response dataset that followed that expectation, except for a large spike from a location known as a favored location for fraudulent activity, can identify a potential problem. Screening for URLs or domains known to be associated with fraudulent activity would also be carried out. Step 124 determines whether the analysis identified any problems and flags those for further review.

In step 132, the behavioral aspects of the data are analyzed by identify possible problems. For example, a click fraud attack that involves employing third-party computers via a virus or other means may generate fraudulent activity at a time when such users are not likely to notice it, such as at odd times of day. Thus, a spike in click activity occurring at 3 AM, for example, or occurring at the same time every day, could flag problems. Further, experience will show relationships, such as between site browsing time and a click action, for example. Users do not often click within a few seconds of downloading a website, for example, so a large volume of such clicks can indicate a click fraud attack. Other relationships and patterns can be discovered from the data itself, using OLAP analysis techniques. That analysis forms the basis for future processing, by allowing the formation of rules against which data can be tested. Decision step 134 can identify problems uncovered in analysis and flag them.

From both tracks, results are fed to step 140, where the evidence is processed to verify the occurrence of fraud and to assemble any information that can be gathered regarding that activity, such as any identification of URL's, domains, or other location data. That step feeds results to system administrators for further follow-up.

An important aspect of the claimed invention is shown in one embodiment of FIG. 1b, which illustrates the data contained in the return message 150 sent from a system displaying advertising to a user, such as a personal computer, to the advertising support server. As shown, that message contains both a machine ID 152 and an ad ID 154, in addition to information such as recency and the like, 156. That information is important for several reasons. First, the ability to associate a particular action with a particular computer allows administrators to pinpoint possible fraudulent activity. It should be noted that concern for safeguarding the privacy of users precludes gathering specific personal information about users; rather, the machine ID identifies only the machine. Of course, that information is usable only retrospectively, after the fraud has been identified. Provision of an ad ID, which specifically ties a machine to a particular ad, allows the system to set a flag the first time a click is received from a given machine. Thereafter, no clicks are accepted for that machine. Thus, an advertiser's concerns about paying for multiple clicks from a single user are alleviated, while stopping click fraud at its source—even though an automated script continues to generate thousands of clicks, not one is actually accepted by the system. Where this embodiment is deployed, it can have a major effect on click fraud attacks.

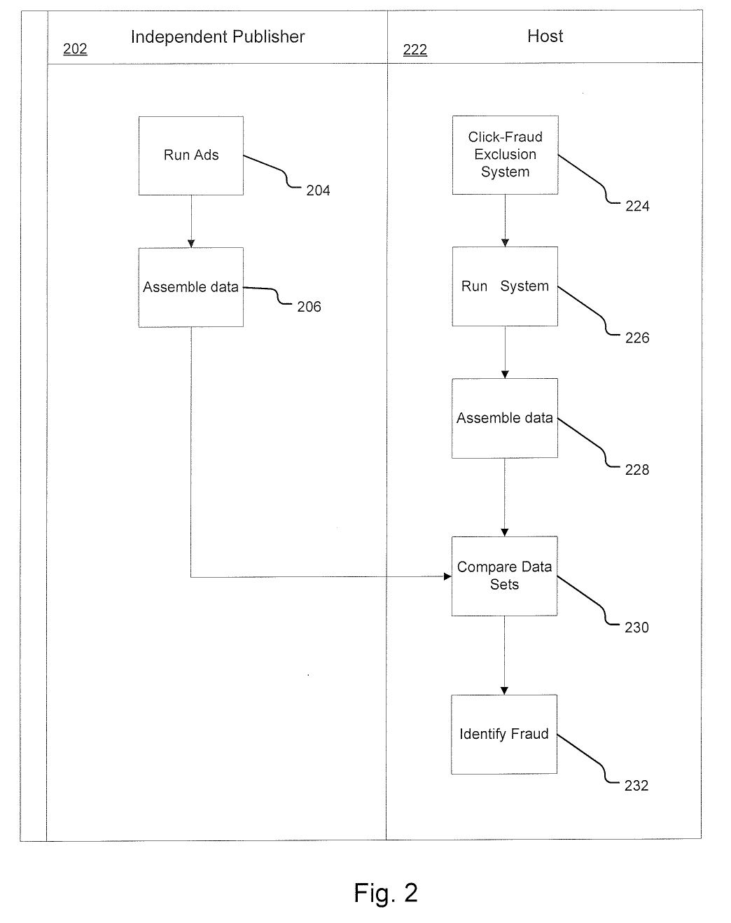

The embodiment of FIG. 1a can be described as primarily useful within a system that performs behavioral analysis and offers advertising to users based on the user's needs and interests. FIG. 2 illustrates another embodiment of the claimed invention, in which the techniques set out herein are employed to analyze data submitted by an independent advertising publisher. The latter terms denotes an organization that publishes advertising for advertisers. In the context of the present invention, that service involves the placement of Internet advertising, generally on affiliate sites. Such an organization does not perform its own behavior analysis, nor does it possess the resources, or perhaps the expertise, to test its responses for click fraud, but it does wish to provide that service for its advertisers.

The process of FIG. 2 can be divided into two tracks, first of those processes performed by the independent advertising publisher, track 202, and those performed by the analysis host, track 222. The publisher first runs ads, shown in step 204, and it assembles the data it receives in response, such as click information and related data, in step 206.

The host, operating completely independently of the publisher, conducts its own operations, in a manner similar to that set out in FIG. 1a, by conducting its internal click fraud exclusion system in step 224, which allows it to run its system, step 226, based on the rules and results generated previously, and to assemble results data in step 228. This last step, as set out about, gives the host a broad picture of Internet usage, showing plenty of instances of both legitimate and fraudulent activity.

The host can thus accept a dataset from the publisher and analyze that data against its accumulated experiential dataset, in step 230, allowing it to identify instances of click fraud in step 232.

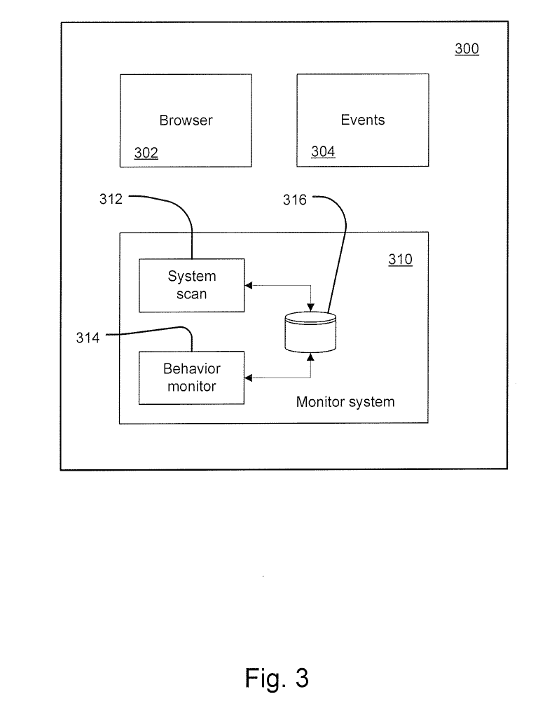

The second major fraudulent activity is phishing, and unlike click fraud, this activity requires focusing on individual computers, not at the server level. FIG. 3 sets out an embodiment of a behavior-watching module, modified to add anti-phishing capabilities to standard behavior monitoring. Here, the user computer 300 includes a browser 302, which can be any of the commonly used and accepted Internet browsers, such as Microsoft Internet Explorer, Firefox, or Opera. The computer also includes an event handler 304. Monitor system 310 operates in the computer, independently of the browser and other communications means. The monitor system tracks activity in the browser by watching the events coming through the event manager.

A completely new addition in this embodiment is the system scan module 312. Not a full-blown virus scanner or anti-spyware system, module 312 does have sufficient power to scan the system to determine whether any resident software is associated with any known sources of fraudulent or spyware software. That result is accomplished by comparing information and rules saved in data store 316 with events, URL's and the like gained through monitoring the browser and event stream. The system scan can operate at the start of a user session, or periodically, or continuously, at the user's option.

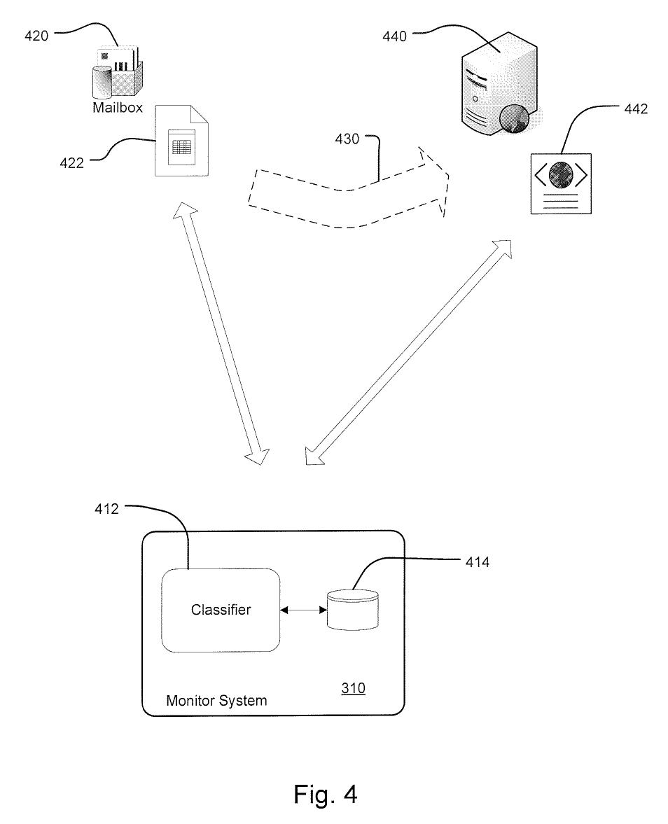

Behavior monitor 314 performs all of the functions noted in the Behavioral Targeting Applications, noted above, and in addition it adds the functionality described below. That functionality is resident in a classifier 412, shown in FIG. 4, which diagrams the general operation of an embodiment of the anti-phishing system. Flowchart 500, in FIG. 6, lays out the process in more detail.

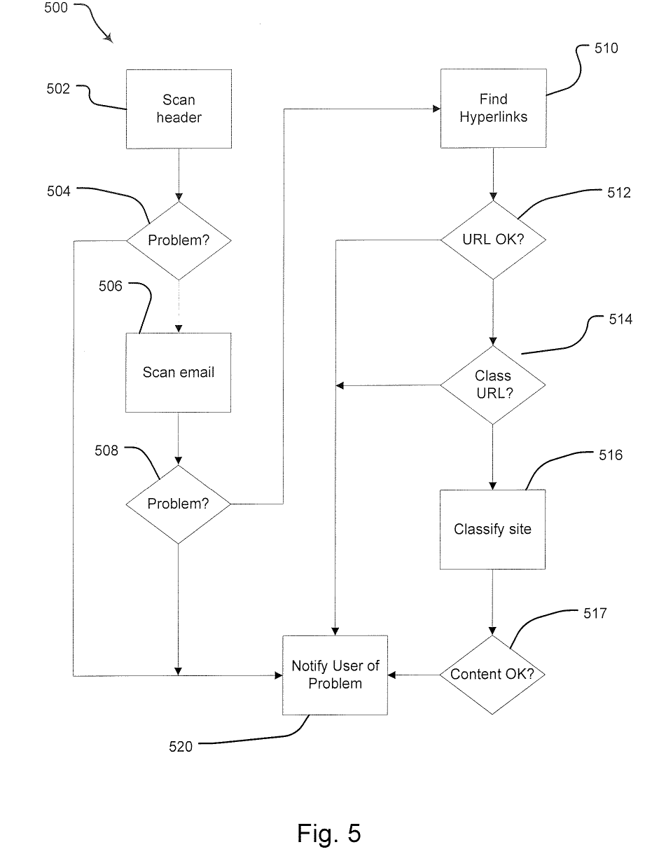

This system is triggered by the user opening an email message 422 in the system mailbox 420 (FIG. 5). The user system includes a classifier 412 within the monitor system 310, and the classifier communicates with the database 414, which contains information provided by the server to user computers, as described in the Behavioral Targeting Applications.

As noted above, phishing most often occurs in connection with email, which then directs a user to a desire webpage, which can steal information and provide virus or other improper software. Thus, the classifier first scans the email message for hyperlinks, which, as is known in the art, link with a remote website site 440 at landing page 442, as indicated by arrow 430. The scanning process is shown in FIG. 5 as well. The classifier first looks to the message header (step 502), in an effort to identify any known email addresses, URL's or other locations that are either known phishing problem areas or locations that raise warning flags, such as the sudden appearance of a site in an odd location, such as, say, Belarus. Any problems are flagged in decision block 504. Then, the classifier proceeds to scan the body of the email, step 506, looking for any text that might trigger an association with data contained on datastore 314, which would be flagged in step 508. Most particularly, that search focuses on the landing page of any hyperlink found in the body of the email, step 510, with a determination whether the URL matches any known site associated with phishing activity, in step 512.

Absent any formal indication of a problem prior art anti-phishing software turns control back over to the user, even though significant risk remains regarding what might happen if the user follows the hyperlink. Instead, the embodiment of FIGS. 4 and 5 proceed to test the landing page, as follows. First, based on the methods and disclosure contained in U.S. application Ser. No. 11/207,589 entitled “Method and Apparatus for Responding to End-User Request for Information—Collecting” filed Aug. 19, 2005, the classifier determines, via an inquiry to the central server, whether the URL contained in the hyperlink has been classified, and if so, what that classification is. In one embodiment the classification is presented to the user for evaluation, while in another a module analyzes the semantic content of the email to determine whether it matches the classification assigned to the landing page. A variance in meaning would produce a warning message to the user.

In the event that the landing page has not been classified, a likely result if that page is involved in fraudulent activity, then the system proceeds to perform a classification, based on the techniques taught in U.S. application Ser. No. 11/207,592 entitled “Method and Apparatus for Responding to End-User Request for Information-Ranking” filed Aug. 19, 2005, in step 516. Again, the results of that classification are either presented directly to the user for comparison with the email, or they are compared with the content of the email message, in step 517. An indication of a potential phishing site results in a notification to the user of that conclusion, in step 520.

We claim:

1. A method for detecting and preventing fraud in Internet-based advertising, comprising the steps of:
tracking and analyzing multiple users Internet navigation activity across multiple content providers;
collecting data regarding the activity, including at least identification of visited websites, time identifications and action identifications;
analyzing the data to determine visited locations or actions likely associated with fraudulent activity; and
identifying behavior patterns in the user activity data consistent with fraudulent advertising activity.

2. The method of claim 1, wherein the analyzing step includes the step of analyzing URL's of visited sites.

3. The method of claim 1, wherein the identifying step includes applying results of past analysis to identify current activity patterns.

4. A method for detecting and preventing fraud in internet-based advertising, comprising the steps of:
providing Internet advertising content to users, including a specific identification for specific instances of advertising content;
tracking and analyzing multiple users Internet navigation activity across multiple content providers;
collecting data regarding the activity, including at least identification of visited websites, time identifications, advertising identifications, machine identifications and action identifications;
analyzing the data to determine visited locations or actions likely associated with fraudulent activity, including associations between machine identifications and advertising identifications; and
identifying behavior patterns in the user activity data consistent with fraudulent advertising activity.

5. The method of claim 4, wherein the tracking and analyzing step further includes setting a flag when receiving a click action regarding a specific advertising instance is associated with a specific machine identification and thereafter accepting as valid no further click actions associated with that machine/advertising identification pair, thereby defeating any attempts at fraudulent activity regarding that advertising instance.

6. The method of claim 4, wherein the analyzing step includes the step of analyzing URL's of visited sites.

7. The method of claim 4, wherein the identifying step includes applying results of past analysis to identify current activity patterns.

8. A method for detecting and preventing fraud in internet-based advertising, comprising the steps of:
providing Internet advertising content to users, including a specific identification for specific instances of advertising content, including;
tracking and analyzing multiple users Internet navigation activity across multiple content providers, including setting a flag when receiving a click action regarding a specific advertising instance is associated with a specific machine identification and thereafter accepting as valid no further click actions associated with that machine/advertising identification pair, thereby defeating any attempts at fraudulent activity regarding that advertising instance.

9. A method for identifying the occurrence of fraud regarding a set of internet advertisements, comprising the steps of:
establishing a system employing fraud-resistant advertising platforms;
collecting data from the system, in a volume sufficient to provide statistical validity;
analyzing system data to identify patterns of fraudulent activity;
accepting a test data set reflecting internet advertising responses collected by an independent advertising publisher;
comparing test data to community data, to determine whether test data was likely to have suffered click-through inflation fraud; and
whether test data was likely to have suffered competitive click-though attack.

10. The method of claim 9, wherein the comparing step includes applying rules and results derived from past analysis to the test data.

11. A method for monitoring possible fraudulent activity within a computer system:
providing a monitor system;
scanning system to identify elements having known association with fraudulent activity;
monitoring system activity to identify activity patterns associated with fraudulent activity; and
notifying user of possible fraudulent activity.

12. The method of claim 11, wherein the scanning and monitoring steps include comparing current system contents and activity to rules received from a central monitoring system.

13. A method for identifying phishing threats in an individual computer system, comprising the steps of
scanning the headers of incoming emails to identify domains associated with phishing sites;
scanning incoming email messages for hyperlinks;
testing the hyperlinks, including the steps of
determining whether the hyperlink landing site is associated with phishing activities;
classifying undetermined sites to identify the content of the landing page and associated sites.

14. The method of claim 13, wherein the determining step includes comparing the site identified in the hyperlink under test with known sites associated with phishing activity.

15. The method of claim 13, wherein the classifying step further includes notifying the user of the results of the step.

16. The method of claim 13, wherein the classifying step further includes analyzing the content of the landing page and associated sites to determine the legitimacy of the.

17. A method for preventing fraudulent responses to Internet advertising, comprising the steps of:
presenting an advertisement to an internet user;
collecting response information from users exercising affirmative responses to the advertising, including collecting at least a substantive user response and a user identification code;
accepting the response information only if the collected information is the first response to the advertising presented material from the identified user.
